(19) United States
(12) Patent Application Publication
(10) Pub. No.: US 2011/0146669 A1
(43) Pub. Date: Jun. 23, 2011

(54) SOLAR THERMAL PANEL

(75) Inventors: Anthony J. Bartol, Plymouth, WI (US); Neal R. Verfuerth, Plymouth, WI (US)

(73) Assignee: Orion Energy Systems, Inc.

(21) Appl. No.: 12/646,739

(22) Filed: Dec. 23, 2009

(51) Int. Cl. F24J 2/46; B23P 15/26

(52) U.S. Cl. 126/704; 29/890.033

(57) ABSTRACT

A solar thermal panel includes an integrally formed base including a rectangular bottom, four walls, four corners, and a top lip. Four corner brackets each have a leg portion coupled to adjacent walls and a foot portion extending outwardly from the leg portion. A spacer is disposed atop the top lip and a cover is disposed atop the spacer. A trim strip has a first leg that abuts a top edge of the corner bracket and a second leg that overlaps an outer edge of the cover. A layer of sealant is disposed within a space at least partially defined by the trim strip, the cover, the spacer, and the top lip. Parallel supply and return headers extend through an enclosure defined at least partially by the base and the cover, and a plurality of fin-tubes extend between the supply and return headers.

### FIELD

The present disclosure relates to a solar thermal panel and a method of making a solar thermal panel. The solar thermal panel includes a fin-tube arrangement that is offset from supply and return headers. The solar thermal panel also includes corner brackets that provide dimensional control for assembling components of the panel and increased mounting flexibility. The solar thermal panel also includes flexible connections for coupling multiple panels to facilitate ease of installation and to accommodate thermal expansion. The solar thermal panel further includes a thermal management concept to protect heat-sensitive components during assembly.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

It is generally known to provide a solar thermal panel for using sunlight to heat a working fluid. Some solar panels use a concentrator for focusing sunlight on a collector that heats the working fluid (e.g. “solar concentrators”). Other solar panels may use a heat absorbing material to transfer heat generated from sunlight to the working fluid (e.g. “solar thermal panels”). However, such known solar thermal panels and the method of making them have certain disadvantages. Accordingly, it would be desirable to provide a solar thermal panel and a method of making such a solar thermal panel that overcomes the disadvantages of the known panels. It would be desirable to provide a solar thermal panel that includes a fin-tube arrangement that is offset from supply and return headers. It would also be desirable to provide a solar thermal panel that includes corner brackets that provide dimensional control for assembling components of the panel and improved mounting flexibility for use with a variety of support frames or mounting structures. It would also be desirable to provide a solar thermal panel that includes flexible connections for coupling multiple panels to facilitate ease of installation, reduce stress on the panel components and to accommodate thermal expansion. It would also be desirable to provide a solar thermal panel that includes a thermal management concept to protect heat-sensitive components during assembly activities.

### SUMMARY

One embodiment relates to a solar thermal panel having an integrally formed base including a substantially rectangular bottom portion, four walls, four corners, and a top lip. Four corner brackets are provided, each corner bracket having a leg portion coupled to adjacent walls and a foot portion extending outwardly from the leg portion. A spacer is disposed atop the top lip and a cover is disposed atop the spacer. A trim member has a first leg that abuts a top edge of the corner bracket and a second leg that overlaps an outer edge of the cover. An adhesive sealant is disposed within a space defined at least partially by the trim strip, a protective glazing, the cover, the spacer, and the top lip to secure the cover in position. A supply header and a return header are disposed substantially parallel to one another and extend through an enclosure defined at least partially by the base and the cover, and a plurality of fin-tubes extend between the supply header and the return header.

Another embodiment relates to a solar thermal panel and includes an integrally formed base having a substantially rectangular bottom portion, four walls, four corners, and a top lip. A spacer is disposed atop the top lip and a cover is disposed atop the spacer. A supply header and a return header are disposed substantially parallel to one another and extend through an enclosure defined at least partially by the base and the cover. A plurality of fin-tubes extend between the supply header and the return header. A first spool piece having a first face seal flange is coupled to an end of at least one the headers, and a second spool piece having a second face seal flange is coupled to the first spool piece, and flexible fluid connection such as a bellows made from a material free from galvanic corrosion is coupled to the second spool piece.

Another embodiment relates to a method of making a solar thermal panel and includes the steps of forming a piece of sheet material into a base having a bottom, walls and a top lip, installing a thermal insulation material on the bottom and at least partially along the walls to a predetermined height that provides a gap between the insulation and the top lip, installing an edge holder at least partially within the gap and/or on the edges of the fin tube assembly, forming corner brackets having a foot portion and a leg portion, applying a sealant to an inside surface of the corner brackets and securing the corner brackets to the walls of the base, installing a fin-tube and header assembly within the base and supporting the headers within openings in the corner brackets, mounting a spacer atop the top lip, placing a cover atop the spacer, applying an adhesive sealant proximate an outer edge of the cover and extending substantially about the perimeter of the cover, and installing a trim member along the outer edge of the cover so that a bottom leg of the trim member abuts a top surface of the corner bracket, and so that an upper leg of the trim member overlaps the outer edge of the cover and the layer of adhesive sealant is conformed into the space surrounding the outer edge of the cover.

### BRIEF DESCRIPTION OF THE DRAWINGS

FIG. 1 is a schematic representation of a perspective view of a solar thermal panel according to one exemplary embodiment.

FIG. 2 is a schematic representation of an exploded perspective view of the solar panel of FIG. 1 according to one exemplary embodiment.

FIG. 3 is a schematic representation of a cross-sectional view along lines 3-3 of the solar panel of FIG. 1 according to one exemplary embodiment.

FIG. 4 is a schematic representation of a cross-sectional view along lines 4-4 of the solar panel of FIG. 1 according to one exemplary embodiment.

FIG. 5A is a schematic representation of a detailed view of a flexible coupling portion of the solar panel of FIG. 1 according to one exemplary embodiment.

FIG. 5B is a schematic representation of a cross-sectional perspective view along line 5B-5B of the flexible coupling portion of FIG. 5A according to one exemplary embodiment.

FIG. 5C is a schematic representation of an exploded cross-sectional perspective view of the flexible coupling portion of FIG. 5B according to one exemplary embodiment.

FIG. 5D is a schematic representation of an cross-sectional view of the flexible coupling portion of FIG. 5A according to one exemplary embodiment.

FIG. 6A is a schematic representation of a perspective view of a portion of a solar thermal panel illustrating a mounting arrangement according to one exemplary embodiment.

FIG. 6B is a schematic representation of a perspective view of a portion of a solar thermal panel illustrating a mounting arrangement according to another exemplary embodiment.

### DETAILED DESCRIPTION

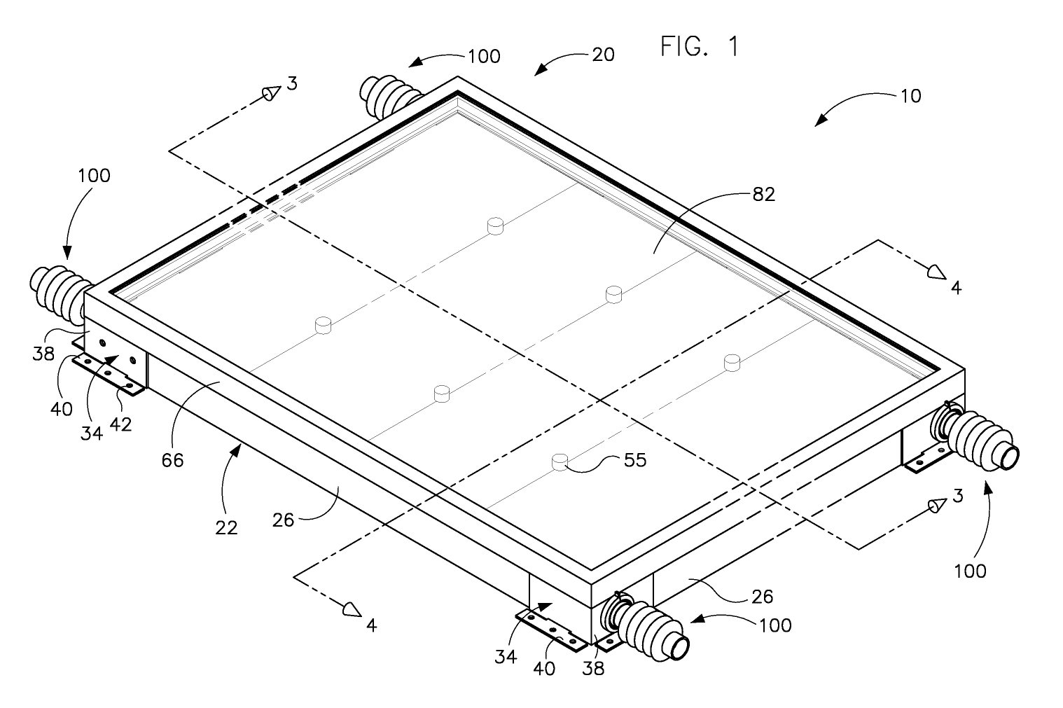

Referring generally to FIGS. 1-5D, a solar thermal panel 10 and its components are shown generally according to an exemplary embodiment. Solar thermal panel 10 is shown to include, among other features, an innovative enclosure that supports supply and return headers (e.g. manifolds, etc.) for delivery of a working fluid to a plurality of individual tubes having one or more fins (e.g. “fin-tube”), where the tubes are shown coupled to the headers in an offset manner and the fins are made from (or otherwise include) a heat-conductive material having high absorptive properties for absorbing energy from sunlight and transferring this energy in the form of heat to the working fluid flowing within the tubes. The enclosure for the panel is shown to include corner brackets that provide dimensional control and support for assembling components of the panel in a durable and robust manner. The corner brackets also include features to facilitate a variety of mounting configurations for mounting the panel(s) at a desired location (e.g. rooftop of a facility, etc.). Flexible connections are provided for joining the supply and return headers of the panel to adjacent panel(s) or other components to facilitate ease of installation, reduce mounting stresses that might otherwise be transferred to the panel, and to accommodate thermal expansion. The solar thermal panel further includes a thermal management concept to protect heat-sensitive components during activities for assembling the components of the panel (e.g. brazing, soldering, etc.). The solar thermal panel of the present disclosure is intended for use in heating a working fluid (e.g. water, glycol, water-glycol mixture, etc.) that is circulated (e.g. by a pump or the like) for use in a facility (e.g. domestic hot water supply or preheating thereof, heating a facility, etc.). According to alternative embodiments, the solar thermal panel may be used for heating fluids intended for use in other applications.

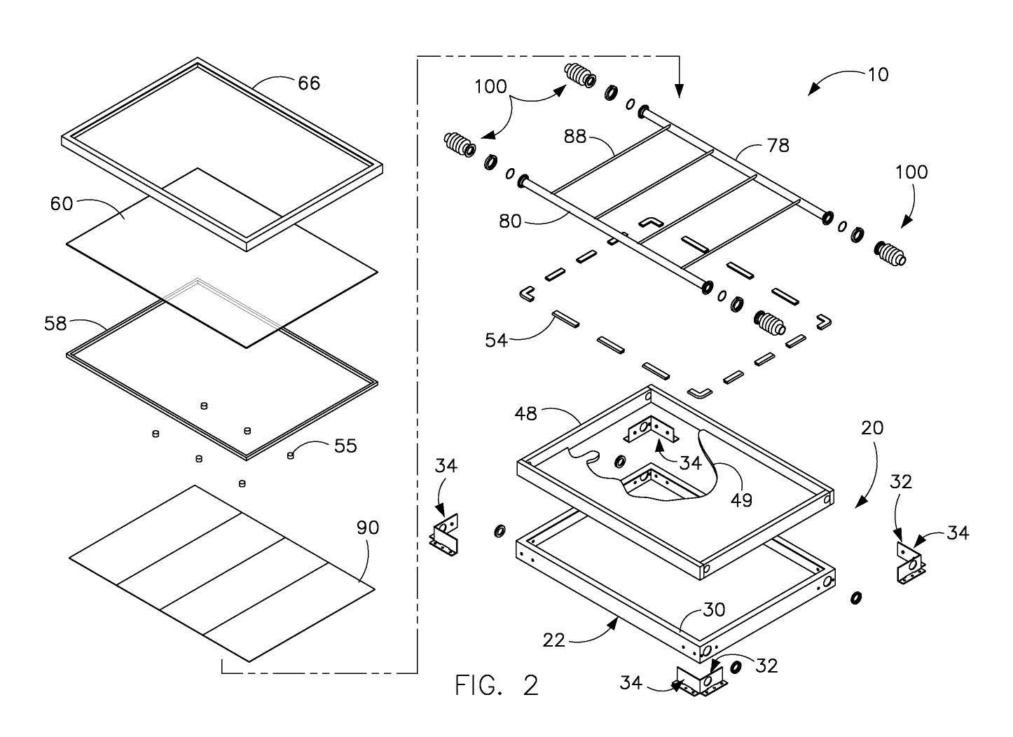

Referring further to FIGS. 1 and 2, solar thermal 10 panel includes an enclosure 28 that contains therein the supply and return headers 78, 80, the fin-tubes 82, and thermal management (e.g. insulation, etc.) materials. Flexible couplings 100 extend from the supply and return 80 headers, and are sealed to the enclosure 20.

The enclosure 20 is assembled from components shown to include a substantially rectangular base 22 (e.g. pan, tray, etc.), corner brackets 34, top edge trim strips 66, a transparent cover 60 (e.g. window, etc.), spacers 58 (e.g. blocks, gaskets, etc.) and an adhesive sealant 62. According to one embodiment, base 22 is formed from a sheet of material (e.g. galvanized sheet metal, sheet aluminum, stainless steel, etc.) to include a generally planar bottom 24 and folded 90 degrees along the sides and ends to form walls 26 (e.g. side walls and end walls), having a vertical corner seam 28 therebetween, and the top portion of the walls are again folded 90 degrees to form a horizontal top lip 30 with mitered edges at each of the four corners. The outer surfaces of the enclosure may include a suitable coating or the like having low emissivity characteristics. Although the solar thermal panel is shown by way of example to be rectangular with four 90 degrees corners, the solar thermal panel of the present disclosure may be formed in any of a wide variety of shapes, with any number of corners formed at corresponding angles. For example, an alternative embodiment of the enclosure may include walls that are tapered downwardly so that the bottom wall has a smaller area than the collective area of the fins on the fin tubes, so that the area of the enclosure that emits and conducts heat away from the panel is reduced, leading to enhanced efficiency. The enclosure may also be provided in any desirable shape intended to suit a particular application. All such modifications are intended to be within the scope of this disclosure.

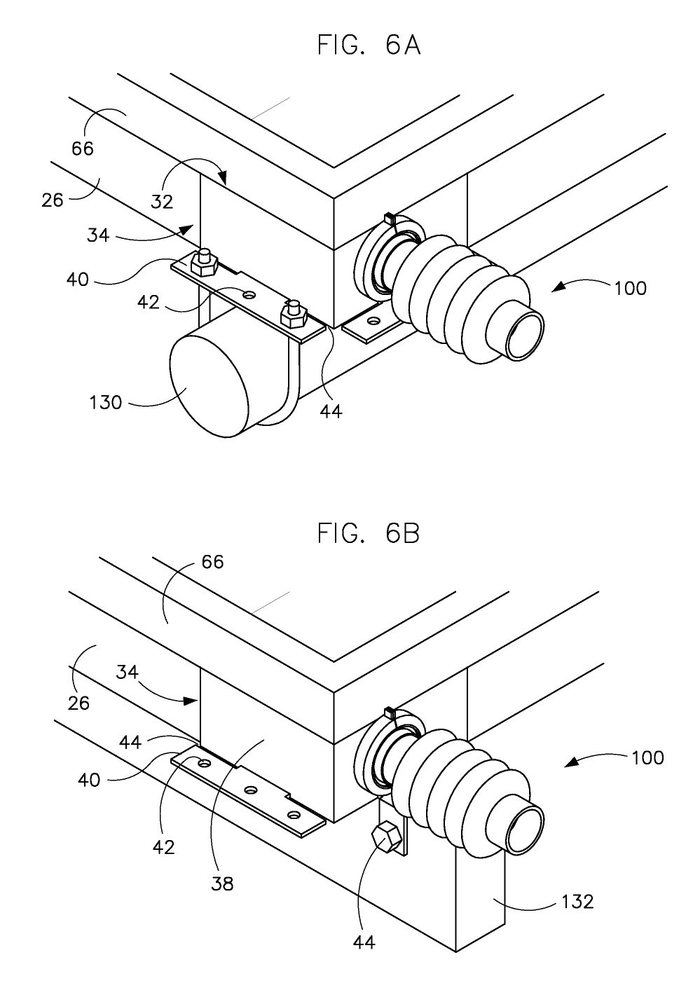

Corner brackets 34 as shown are provided on each of the four corners of the base 22 to seal the vertical seam, and to provide a dimensional tolerance and support fixture for assembling other components of the panel, and to serve as a “universal” mounting bracket for mounting the panel in a variety of desired locations. Corner brackets 34 are shown formed from sheet metal with legs 36 disposed at substantially 90 degrees from one another. Each leg 36 includes a vertical portion or legs 38 for coupling to the walls 26 of the base 22, and a horizontal component (e.g. foot 40, etc.) for use in mounting the panel to a mounting structure in various configurations (shown more particularly and by way of example in FIGS. 6A and 6B). The height of the vertical portions or legs 38 is shown to be lower than the height of the walls 26 and the top of the vertical portion or legs 38 serves as a ledge 32 to support a top edge trim member or strip 66 to be further described herein. According to one embodiment, a sealant (e.g. silicone, hot melt silicone, etc.) is applied (e.g. as a bead or other suitable application) between the vertical portions or legs 38 of the corner bracket 34 and the walls 26 of the base 22 to provide a seal therebetween and to seal the vertical corner seam 28. The sealant is also intended to have thermally insulative properties to reduce heat loss from the panel and thus minimize transfer of heat from the panel to a mounting structure (shown for example in FIGS. 6A and 6B) The vertical portions or legs 38 are then secured to the walls 26 in a suitable manner, such as by staking, however other securement methods may be used, such as riveting, threaded fasteners, brazing, etc.

An insulation material 48 (e.g. a board insulation material such as urethane board insulation) is shown secured (e.g. by adhesive, etc.) to an inside surface of the walls 26 so that a top surface 50 forms a space or gap 52 with the horizontal top lip 30. Another layer of insulation material 49 (e.g. a board insulation material such as urethane board insulation) is shown secured (e.g. by adhesive, etc.) to an inside surface of the bottom 24. The use of urethane board insulation is believed to minimize the potential of out-gassing from the insulation during assembly that might otherwise result in etching of glass used for the cover 60, and also to minimize the potential for absorbing moisture. Gap 52 is sized to receive a generally horizontally configured and U-shaped edge holder 54 for receiving and securing therein an edge of a fin 90 from the fin-tubes 82. Holder 54 may be provided as a generally continuous member, or may be provided in segments. For example, holder 54 may comprise a plurality of segments approximately 1-2 inches long and spaced at approximately 6-8 inch intervals, however any segment length may used at any suitable spacing to maintain a desired position of the fin. Edge holder(s) 54 is formed from a resilient, temperature-resistant material such as silicone rubber, polyamide, or the like and serves to help secure the edges of the fins 90 about the perimeter of the enclosure 20. Edge holder(s) 54 are also intended to provide a thermal break between the edges of the fins and the body of the panel and minimize heat transfer between the fins and the panel body. Edge holder(s) 54 also position the edges of the fins at a generally fixed distance from the cover 60 to maintain a predefined clearance and prevent contact between fins 82 and cover 60.

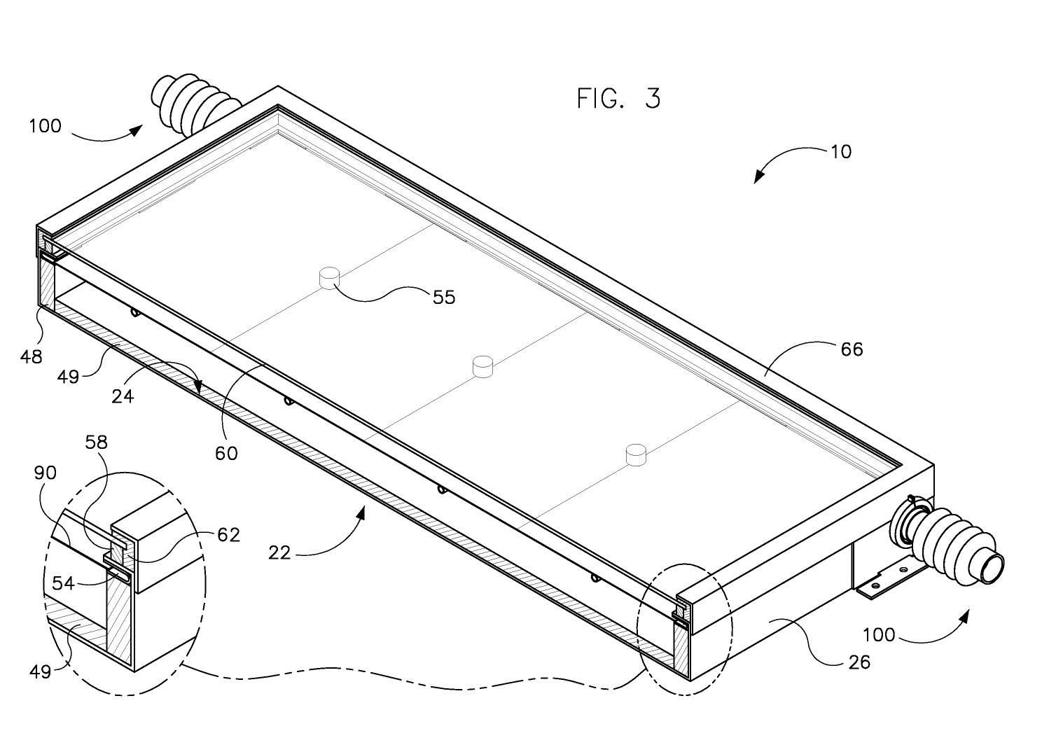

According to the illustrated embodiment of FIG. 3, spacers 55 may be provided between an underside of the cover and the top side of the fin tube assembly to maintain the central portion of the fin-tube assembly at a generally fixed distance from the cover 60 to maintain a predefined clearance and prevent contact between fins 82 and cover 60 in the central region of the panel. For example, spacers 55 may comprise a small extrusion (e.g. glob, etc.) of a high-temperature adhesive sealant, such as a silicone material, applied to the fins (shown for example as overlapping adjacent fin edges) or the cover, which upon assembly adheres to the fin and cover and cures to provide a resilient spacer between the fin and cover. According to alternative embodiments, the spacer may be any suitable member having a high temperature resistance to withstand the heat from the fin, and small size to minimize loss of solar collection on the fin surface. The spacers 55 are preferable located at suitable intervals to prevent contact between the fin and the cover, such as, for example, incremental spacing every one-third length of the fin-tube assembly. According to one embodiment, spacers 55 may comprise the same material as sealant 62 to facilitate rapid assembly of the pane. The location of the spacers on the top side of the fins (i.e. between the fins and cover) is intended to avoid placement of retaining structure beneath the fins, in order to enhance thermal management of the panel components.

Spacers 58 (e.g. gaskets, etc.) are installed upon the top surface of horizontal top lip 30 and substantially about the perimeter of the enclosure 20 and are secured in place in a suitable manner, such as adhesive, two-sided tape, etc. According to one embodiment, spacers 58 are formed from a high-density foam material or silicone rubber, and are configured in the shape of strips that extend along the length of the tops of the walls. The cover 60 is positioned on, and supported by, the spacers 58 to provide a cover for the enclosure 20. According to one embodiment, cover 60 is formed from glass and is sized to provide a small setback dimension from the walls 26 about the perimeter of the enclosure 20. The cover 60 is shown sealed to the base 22 by application of a sealant 62 (e.g. a bead of silicone, hot melt silicone, etc.) about the perimeter of the cover 60 so that the sealant 62 overlays the top, bottom and side edge 64 of the cover 60. The sealed cover 60 is also secured to the base by the sealant 62 (upon curing) and the cover 60 is protected by top edge trim members or strips 66 having a downwardly-extending (e.g. lower) vertical leg 68 and a horizontally-extending upper leg 70. The bottom leg 68 has a dimension 70 such that when its lower edge rests on the ledge 32 atop the corner brackets 34, the upper leg 70 overlaps the outer edge 64 of the cover 60 and provides a gap which is filled with the sealant as the sealant is ‘forced’ or otherwise conformed to fill the space defined between the top edge trim strip 66, the cover 60, the top lip 30 and the spacer 58. According to one embodiment, the top edge trim strips 66 are provided as four separate pieces having mitered corners for installation atop the four walls of the base, however the top edge trim strip may be provided as more pieces, or as fewer pieces (or even one piece in the manner of a “picture frame” or the like). The trim strips may also be provided in a particular color intended to match or coordinate with other components, such as frame members supporting the panels, flexible fluid couplers, or other components, to enhance the aesthetic appearance of the panels or a mounted assembly of panels.

The height of the lower leg 68 and the height of the spacer 58 are selected so that a suitable space is provided above and below the cover 60 (and about the perimeter of the base 22) to contain the sealant 62 therein. This dimensional spacing is accomplished by stacking the top edge trim strip 66 atop the corner brackets 34 so that the cover 60 and sealant 62 are suitable compressed between upper leg 70 and the horizontal top lip 30 so that a desired extrusion of the sealant 62 occurs and the cover 60 is retained and secured at a substantially uniform and controlled elevation above the fin-tubes 82 to prevent contact between the glass cover material and the fins 82. Upon curing of the sealant 62, the cover 60, the top edge trim strips 66 and horizontal top lip 30 are sealed and secured to one another in a durable and relatively shock-resistant manner. The enclosure 20 is thus also sealed at its upper seams (i.e. the side generally most exposed to environmental conditions) to prevent intrusion of contaminants such as dirt or moisture (e.g. to prevent or minimize condensation, etc.) which over time may tend to impede or reduce the amount or intensity of sunlight available at the surface of the fin-tubes. The lower portion of the panel may include suitable vents to accommodate the cyclical temperature changes of the panel (e.g. between daytime and nighttime, etc.). According to one embodiment, the vent may have a filter or other suitable device on a bottom surface of the panel to permit air exchange but minimize introduction of contaminants, such as protective vents commercially available from W.L. Gore & Associates or the like. The interaction of the top edge trim strip 66, corner bracket 34 and spacer 58 also permits the cover 60 and top edge trim strip 66 to be fixed in place while the sealant 62 cures, so that additional panels can be quickly stacked thereon during assembly and/or shipping operations without impacting the vertical stack dimension of the panel components and the curing of the sealant. The ability of the panels to be assembled directly upon one another to accommodate stacking and curing operations without the use of separate supports or the like is intended to reduce the number of components, floor space, time and cost associated with manufacturing the panels.

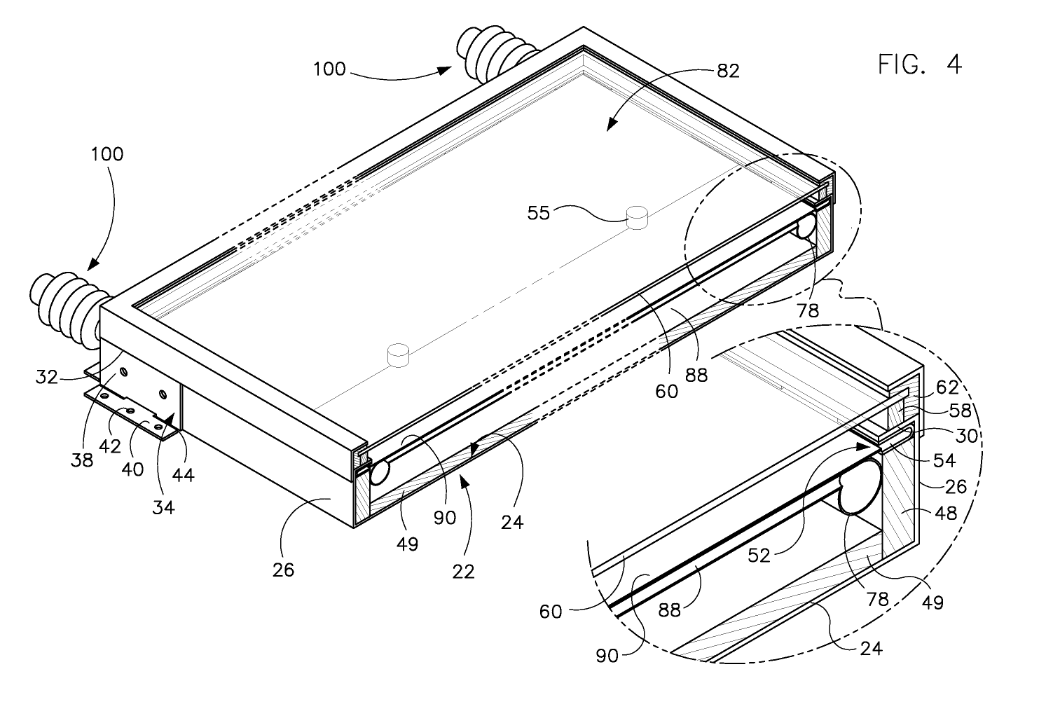

Referring further to FIGS. 3 and 4, a supply and return header and fin-tube assembly 76 is shown to include the supply and return headers and fin-tubes 82 of the solar thermal panel 10 according to an exemplary embodiment. Supply header 78 and return header 80 are formed from pipe or tubing, such as copper tubing, and extend the length of the panel 10 generally parallel to one another and adjacent to opposite sides, and extend through apertures 84 in the walls 26 and the corner brackets 34 of the enclosure 20. The headers 78, 80 are spaced at a predetermined distance apart from one another in each panel 10 in order to facilitate alignment of panels and interconnection of headers at installations with multiple, adjacent panels. Preferably, the manifolds are spaced a maximum distance apart from one another within the enclosure to maximize the fin surface area for collection of solar energy by the panel. The headers 78, 80 may be supported within the apertures 84 by collars 86 (e.g. grommets, or other suitable supports, etc.) that provide a seal between the wall 26 of the enclosure 20 and the outer surface of the headers 78, 80. According to one embodiment, the collars 86 are formed from a resilient (e.g. flexible, cushioned, etc.) and high-temperature resistant material such as silicone rubber, dense silicone rubber foam, or the like. The use of resilient supports such as collars 86 are intended to permit the headers 78, 80 (and the connected fin-tubes 82) to “float” to a certain extent within the enclosure 20, which is believed to minimize stress on the components and reduce the potential for leakage in the fluid path and minimize the potential for loss of seal at the cover seams of the enclosure. The high-temperature resistant material of the collars 86 are also intended to provide a thermal break between the headers 78, 80 and the enclosure 20.

A plurality of fin-tubes 82 extend between the supply and return headers 78, 80 for directing a flow of working fluid from the supply header 78, along the length of the fin-tube 82 and to the return header 80, for delivery of heated working fluid to an end use or load (such as a water heater, etc.). According to one embodiment, the tube portion 88 of the fin-tubes 82 joins the headers 78, 80 in a generally perpendicular manner (with respect to flow direction), and in axially-offset manner so that the central axis of the tube portion 88 is spaced above the central axis of the headers 78, 80. One benefit of the offset configuration of the tubes from the header is intended to facilitate manufacturing operations by creating a “self-fixturing” relationship between the header and tube, such that an open recess (e.g. pocket, etc.) milled in the header receives the tube on the header for ease of machining and assembling the tube and header. The offset configuration is also intended to more readily permit extension of the ends of the fins over the headers to maximize the overall surface area of the fins for improved solar collection. The tube 88 is preferably formed from a material having good heat-conductive properties, such as aluminum, copper, etc. and joined to the headers 78, 80 by a suitable operation (e.g. laser welding, ultrasonic welding, brazing, soldering, etc.). According to one embodiment, the offset may be such that the top outer wall of the tube portion 88 of the fin-tube 82 approaches, or substantially is, tangential with the top outer surface of the headers 78, 80. According to one embodiment, for each of the fin-tubes 82, a single fin 90 is shown having a mid portion attached along a top surface of the tube 88 and extending substantially along the entire length of the tube 88. The tubes 88 are provided with a spacing such that the lateral edges of the fins 90 are closely adjacent to one another and occupy substantially all of the length of the enclosure 20. According to one embodiment, (not shown) the fins may have a length that extends over and/or beyond each of the headers to maximize the available surface area of the fins within the enclosure. According to an alternative embodiment, the tubes may be configured as a single tube (or multiple tubes—depending upon the size of the panel) having a serpentine configuration along an underside of the fins, all such modifications are intended to be within the scope of the disclosure.

The tube 88 is preferably formed from a material having good heat-conductive properties, such as copper. The fins 90 are preferably formed from a material having good heat-conductive properties (e.g. copper, aluminum, etc.) and are provided with (or otherwise include) a highly absorptive, low emissivity coating or treatment on the surface to maximize absorption of energy from sunlight. According to one embodiment, the fins 90 are commercially available from Alanod-Solar GmbH & Co. KG of Germany, or Thermofin of Canada. The fins 90 are preferably attached to the tubes 88 in a manner that maximizes the efficient transfer of heat from the fins 90 to the working fluid flowing through the tubes 88.

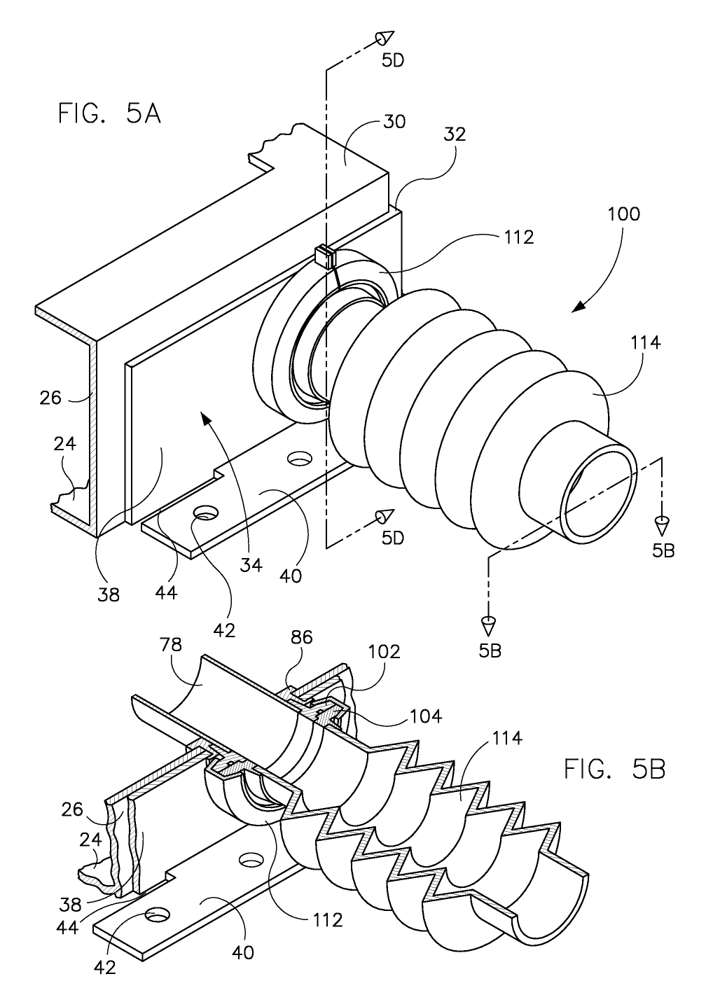

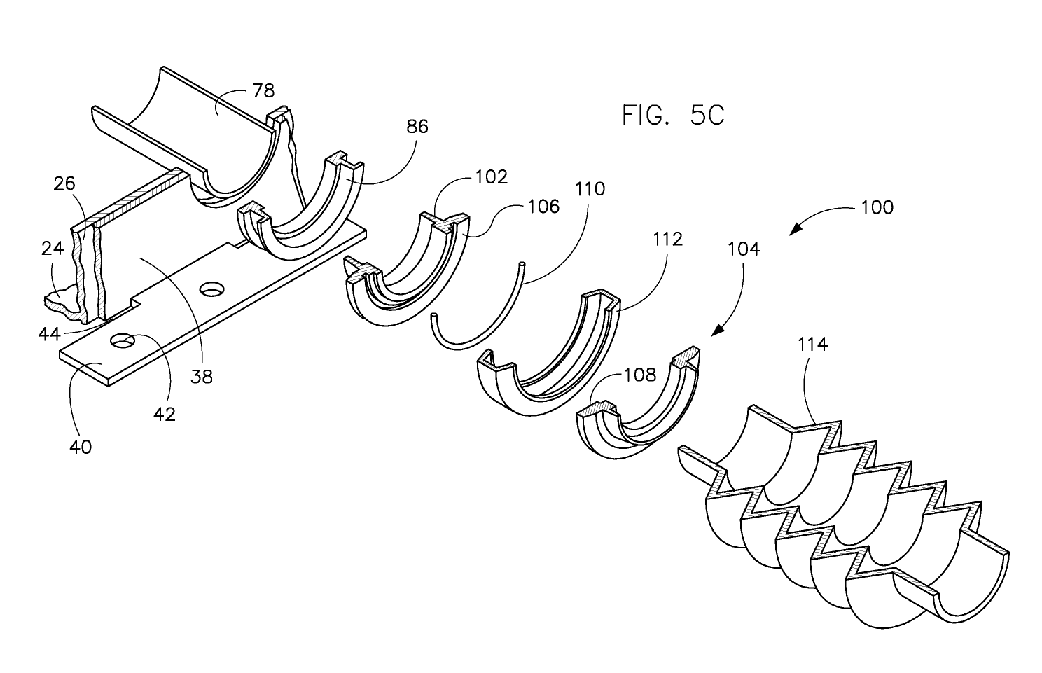

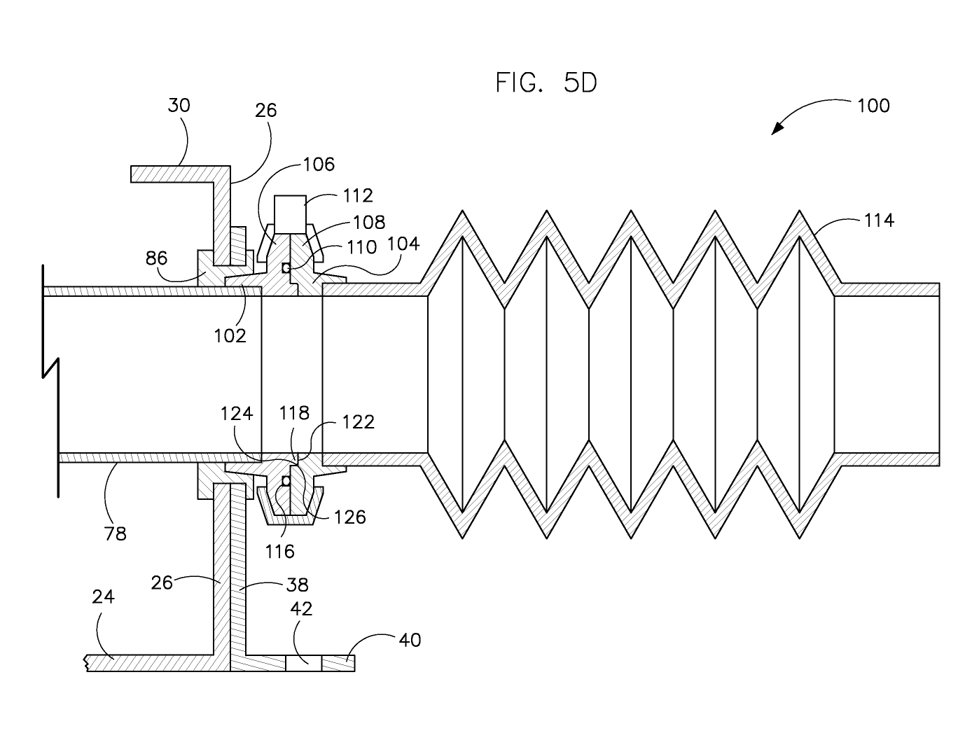

Referring to FIGS. 5A-5D, flexible connectors 100 are shown for fluidly coupling the headers 78, 80 of one panel 10 to the headers of adjacent panel(s) or to other components (e.g. a main supply or return line, a load, etc.), in a manner that facilitates quick and easy installation that minimizes the potential for installation errors and accommodates thermal expansion and contraction of the headers among adjacent panels, and prevents or minimizes the possibility of galvanic corrosion of the components. Flexible coupling 100 is shown to include collar 86, first and second spool pieces 102, 104 with face seal flanges 106, 108 having an O-ring 110 therebetween, a clamp 112 and a bellows 114. According to an alternative embodiment, the flexible connectors may be provided as flexible hose or tubing (e.g. reinforced rubber hose or the like that may be color coordinated with the trim pieces and secured to the ends of headers 78, 80 with suitable hose clamps or the like.

The first spool piece 102 with face seal flange 106 is shown to engage the end (e.g. stub) of the header 78 (80) (e.g. via flared connections or other suitable connection type) and secured within the collar 86 (e.g. by brazing, swaging, etc.). The spool piece may also include a profile intended to create an interference fit with the header, and may include an O-ring that both enhances the interference fit and provides an additional sealing boundary. The second spool piece 104 with face seal flange 108 is attached (e.g. by brazing, etc.) to an end of the bellows 114. One of the face seal flanges (shown by way of example as the first face seal flange 106) includes a groove 116 for seating of the O-ring 110 therein, and has a projecting alignment step 118. The other of the face seal flanges (shown by way of example as the second face seal flange 108) has a generally planar surface 120 for sealing against the O-ring 110 and a corresponding notch or recess 122 configured to mate with the projecting step 118. When both face seal flanges 106, 108 are brought together and tightened, the faces 106, 108 directly contact one another to provide an assembly that is not torque-sensitive, thus allowing more field-assembly using a less-skilled workforce with improved results and reliability of the joint connection. According to another embodiment, the step 118 may include a substantially sharp, 90 degree corner edge 124 configured to interface with a corresponding chamfer or bevel within the recess, so that the corner edge intentionally deforms or “crushes” against the bevel 126 when the step 118 and recess 122 contact one another, such that the crushed edge provides a secondary seal and the O-ring 110 provides a primary seal. A clamp 112 (e.g. band clamp, etc.) is provided over the face seal flanges 106, 108 of both spool pieces 102, 104 and tightened to secure the spool pieces 102, 104 to one another in a sealed configuration. In a similar manner, a like set of spool pieces and sealing components are provided on the opposite end of the bellows for coupling to the corresponding headers of an adjacent panel. According to an alternative embodiment, the thermally expanding and contracting components of the connectors may be moved inside of the panels to avoid use of an external bellows and permit closer spacing of panels adjacent to one another. Such an embodiment may include a two-piece header segment that is intended to permit the headers ends outside the panels to be connected to one another by a short spool piece or the like.

Referring to FIG. 6A, a mounting configuration for mounting the panels 10 on a supporting structure 130 is shown according to an exemplary embodiment. The corner brackets 34, in addition to their function of supporting the enclosure 20, also include a foot portion 40 that serves as a universal mounting device. Foot portion 40 includes apertures 42, at least several of which have a spacing corresponding to one or more standard-sized U-bolts that permit attachment of the panel 10 directly to a support frame member 130 by securing the ends of the U-bolt through the apertures.

Referring to FIG. 6B, a mounting configuration for mounting the panels 10 on a supporting structure 132 is shown according to another exemplary embodiment. The foot portion 40 also includes slots 44 that permit the ends of the foot 40 to be readily bent in a variety of configurations (e.g. up, down, slanted, twisted, curved, etc.) that permits attachment (by suitable fasteners 46 or the like) to other support members of various sizes and shapes. According to alternative embodiments, a high-friction interface material (e.g. abrasive sheet materials such as grit or sandpaper, etc.) may be provided between the foot and the support member to further minimize or prevent movement of the bracket relative to the support member after the foot is secured to the support member. According to any exemplary embodiment, the universal nature of the mounting foot portion of the support bracket permits a variety of configurations intended to attach to a support structure (e.g. framework, etc.) easily and quickly, and in a manner that minimizes the transfer of any stress to the enclosure and the glass material of the cover.

According to any exemplary embodiment, a method of making a solar thermal panel includes any one or more of the following steps or activities (which may be conducted in any desired sequence).

1. Forming a piece of sheet material into a base 22 having a generally planar bottom 24, vertical walls 26 and a substantially horizontal top lip 30. The top lip 30 may have mitered corners.

2. Installing a thermal insulation material 48 on the bottom 24 of the enclosure 20, and along the walls 26 of the enclosure 20. The wall insulation materials having a predefined height that provided a substantially uniform gap 52 between the insulation 48 and the horizontal top lip 30.

3. Installing one or more generally horizontal and U-shaped edge holders 54 at least partially within the gap 52.

4. Forming four corner brackets 34 having a foot portion 40 and a vertical leg portion 38, and providing a plurality of apertures 42 in each foot portion 40 and a slot 44 proximate each end of the foot portions 40 to facilitate custom-bending of the ends of the foot portions 40.

5. Applying a sealant to an inside surface of the corner brackets 34 and securing (e.g. staking, etc.) the corner brackets 34 to the walls 26 at the corners of the base 22.

6. Providing or otherwise obtaining a plurality of fin-tubes 82 by coupling an elongated fin 90 lengthwise along the length of the tube 88.

7. Coupling the plurality of fin-tubes 82 to oppositely-disposed and substantially parallel supply and return headers 78, 80, and installing spacers (e.g. globs of silicone material, etc.) at incrementally spaced locations along the fin edges corresponding to a central region of the panel and intended to contact an underside of the cover upon assembly of the cover to the panel to maintain a predetermined clearance.

8. Maximizing the solar collection surface area of the fin-tubes 82 by spacing the supply and return headers 78, 80 as far apart as permitted by the location of the walls 26 (and insulation 48 if used) and extending the fin portion 82 of the fin-tubes at least partially over the supply and return headers 78, 80.

9. Mounting the fin-tube and header assembly 76 in the enclosure 20 with the headers 78, 80 supported by resilient collars 86 within openings 84 in the walls 26 and/or corner brackets 34 of the base 22, and fitting a perimeter edge of the fins 90 of at least a portion of the fin-tubes into the U-shaped edge holder 54. Alternatively, the edge holder(s) 54 may be mounted on the edges of the fins and then the fins with the holders may be installed into the gap between the top of insulation 48 and the lip 30.

10. Attaching a spacer 58 atop the horizontal top lip 30 and securing it thereto, the spacer 58 extending substantially about the perimeter of the base 22.

11. Placing a cover 60 atop the spacer 58 and in contact with spacers 55.

12. Applying an adhesive sealant 62 proximate the outer edge 64 of the cover 60 and extending substantially about the perimeter of the cover 60 to secure and seal the cover 60 to the walls 26 of the base 22.

13. Attaching a top edge trim strip 66 along each side of the cover 60 so that a bottom leg 68 of the edge trim strip 66 abuts and is supported upon a ledge 32 of the corner bracket 34, and so that the upper leg of the top edge trim strip 66 overlaps the outer edge 64 of the cover 60 and the sealant 62 is forced or otherwise conformed into the space surrounding the outer edge 64 of the cover 60.

14. Attach a first spool piece 102 with face seal flange 106 to the ends of each of the headers 78, 80 using flared connections or other suitable connection types (e.g. brazing, swaging, etc.). Protective shipping closures, caps, blocks or other temporary components may also be installed to protect sensitive elements and maintain appropriate clearance during assembly, handling and shipping of the panel.

15. While the adhesive sealant 62 is curing, stacking another base atop the panel 10 and continue assembling the next panel (atop the first panel while the adhesive sealant in the first panel is curing) according to steps 2-13.

According to any exemplary embodiment, a method of installing a solar thermal panel 10 includes any one or more of the following steps or activities.

1. Aligning one or more holes 42 in a foot portion 40 of at least one corner bracket 34 and securing the foot portion 40 to a support member 130, 132 with a threaded fastener 46.

2. Custom-bending slotted ends of the foot portion 40 of a corner bracket 34 to adapt to the structure and size of a support member 130, 132 and securing at least one foot 40 end to the support member 130, 132.

3. Coupling a second spool piece 104, having a bellows 114 attached thereto with another second spool piece attached to an opposite end of the bellows 114, to the first spool piece 102 and installing/tightening a band clamp 112 about at least a portion of the first and second spool pieces 106, 108.

4. Coupling the other second spool on the opposite end of the bellows 114 to another first spool piece extending from another solar thermal panel to form an assembly of connected panels.

It is also important to note that the solar thermal panel and method of making and installing a solar thermal panel, as shown and/or described, are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited herein. Many modifications are possible without departing from the scope of the invention unless specifically recited in the claims. For example, the sealant may be any suitable sealant applied in any suitable manner. Further, the sealant may have properties that cause expansion of the sealant upon application or during curing to further enhance sealing of the cover to the base. Accordingly, all such modifications are intended to be included within the scope of the present disclosure as described herein. The order or sequence of any process or method steps may be varied or re-sequenced according to alternative embodiments. Other substitutions, modifications, changes, and/or omissions may be made in the design, operating conditions and arrangement of the preferred and other exemplary embodiments without departing from the exemplary embodiments of the present disclosure as expressed herein.

What is claimed is:

1. A solar thermal panel, comprising:
an integrally formed base including a substantially rectangular bottom portion, four walls, four corners, and a top lip;
four corner brackets, each corner bracket having a leg portion coupled to adjacent walls and a foot portion extending outwardly from the leg portion;
a spacer disposed atop the top lip;
a cover disposed atop the spacer;
a trim strip having a first leg that abuts a top edge of the corner bracket and a second leg that overlaps an outer edge of the cover;
an adhesive sealant disposed within a space defined at least partially by the trim strip, the cover, the spacer, and the top lip, the adhesive sealant configured to seal and secure the cover to the base;
a supply header and a return header disposed substantially parallel to one another and extending through an enclosure defined at least partially by the base and the cover; and
a plurality of fin-tubes extending between the supply header and the return header.

2. The solar thermal panel of claim 1 wherein the fin-tubes comprise a tube coupled to the headers at a location offset from an axial centerline of the headers.

3. The solar thermal panel of claim 1 wherein the corner brackets are staked to adjacent walls with a sealant disposed at least partially therebetween.

4. The solar thermal panel of claim 3 wherein the foot portion of the corner bracket comprises at least one slot configured to permit at least part of the foot portion to be bent to accommodate attachment to a support member.

5. The solar thermal panel of claim 4 wherein the sealant between the corner brackets and the walls provides thermal insulation to minimize transfer of heat from the panel to the support member.

6. The solar thermal panel of claim 1 wherein the cover comprises a glass panel.

7. The solar thermal panel of claim 1 wherein the height of the leg portion of the corner brackets and the height of the first leg of the trim strip and the height of the spacer and the height of the top lip are configured to secure the cover at a predetermined and substantially uniform height above the fin-tubes.

8. The solar thermal panel of claim 1 further comprising a layer of thermal insulation disposed along the inside of the walls and having a top edge that defines a gap between the top edge and the top lip.

9. The solar thermal panel of claim 8 wherein an edge of a fin portion of at least one of the fin-tubes is disposed at least partially within the gap.

10. The solar thermal panel of claim 9 further comprising a substantially U-shaped edge holder disposed within the gap and about the edge of the fin portion to retain the fin portion at a predetermined clearance from the cover.

11. The solar thermal panel of claim 1 further comprising a plurality of spacers disposed on the fins within a central region of the panel and configured to maintain a predefined clearance between the fins and the cover.

12. The solar thermal panel of claim 1 wherein the ends of the supply and return headers extend at least partially through an aperture in the corner brackets.

13. The solar thermal panel of claim 12 further comprising resilient collars disposed within the aperture in the corner brackets and supporting the ends of the supply and return headers.

14. The solar thermal panel of claim 1 wherein the supply and return headers are disposed closely adjacent to opposite walls of the base, and wherein a fin portion of the fin-tubes extends over the supply and return headers to maximize a solar collection surface area of the fin-tubes.

15. A solar thermal panel, comprising:
an integrally formed base including a substantially rectangular bottom portion, four walls, four corners, and a top lip;
a spacer disposed atop the top lip;
a cover disposed atop the spacer;
a supply header and a return header disposed substantially parallel to one another and extending through an enclosure defined at least partially by the base and the cover;
a plurality of fin-tubes extending between the supply header and the return header;
a first spool piece having a first face seal flange coupled to an end of at least one the headers;
a second spool piece having a second face seal flange coupled to the first spool piece; and
a bellows coupled to the second spool piece.

16. The solar thermal panel of claim 15 wherein at least one of the face seal flanges includes a groove having an O-ring disposed therein and the other of the face seal flanges includes a substantially planar surface configured to compress the O-ring.

17. The solar thermal panel of claim 15 wherein at least one of the face seal flanges includes a step portion having a substantially 90 degree edge and the other of the face seal flanges includes a recess includes a bevel, so that when the step portion and recess contact one another, the edge is at least partially deformed by the bevel.

18. The solar thermal panel of claim 15 further comprising four corner brackets, each corner bracket having a leg portion coupled to adjacent walls and a foot portion extending outwardly from the leg portion.

19. The solar thermal panel of claim 18 further comprising a trim strip having a first leg that abuts a top edge of the corner bracket and a second leg that overlaps an outer edge of the cover.

20. The solar thermal panel of claim 19 further comprising a sealant disposed within a space defined at least partially by the trim strip, the cover, the spacer, and the top lip.

21. A method of making a solar thermal panel, comprising:
forming a piece of sheet material into a base having a bottom, walls and a top lip;
installing a thermal insulation material on the bottom and at least partially along the walls to a predetermined height that provides a gap between the insulation and the top lip;
installing an edge holder at least partially within the gap;
forming corner brackets having a foot portion and a leg portion;
applying a sealant to an inside surface of the corner brackets and securing the corner brackets to the walls of the base;
installing a fin-tube and header assembly within the base and supporting the headers within openings in the corner brackets;
mounting a spacer atop the top lip;
placing a cover atop the spacer;
applying an adhesive sealant proximate an outer edge of the cover and extending substantially about the perimeter of the cover;
installing a trim strip along the outer edge of the cover so that a bottom leg of the trim strip abuts a top surface of the corner bracket, and so that an upper leg of the trim strip overlaps the outer edge of the cover and the adhesive sealant is conformed into the space surrounding the outer edge of the cover.

22. The method of claim 21 further comprising providing a plurality of apertures in each foot portion and a slot proximate each end of the foot portions to facilitate custom-bending of the ends of the foot portions.

23. The method of claim 21 further comprising the step of fitting an edge of one or more fins of the fin-tube and header assembly into the edge bracket.

24. The method of claim 21 further comprising attaching a first spool piece with a face seal flange to an end of a header of the fin-tube and header assembly.

25. The method of claim 21 further comprising stacking a next base for a next panel atop the trim strip and assembling the next panel atop the panel while curing the adhesive sealant in the panel is curing.
